(19) United States
(12) Patent Application Publication
(10) Pub. No.: US 2026/0161438 A1
(43) Pub. Date: Jun. 11, 2026

(54) SUPPORT FOR LEGACY INPUT/OUTPUT DEVICE FUNCTIONALITY FOR VIRTUAL MACHINES

(71) Applicant: Red Hat, Inc., Raleigh, NC (US)

(72) Inventor: Michael Tsirkin, Ra'anana (IL)

(73) Assignee: Red Hat, Inc., Raleigh, NC (US)

(21) Appl. No.: 18/950,431

(22) Filed: Dec. 10, 2024

(51) Int. Cl. G06F 9/455

(52) U.S. Cl. CPC G06F 9/45558; G06F 2009/45579

(57) ABSTRACT

Techniques described herein relate to supporting legacy input/output (I/O) device functionality for virtual machines. For example, an I/O device can be communicatively coupled to a computing system. The I/O device may have an actual identification number. The I/O device may expose a window of I/O device memory to the computing system. The window of I/O device memory may be associated with a virtual I/O port that has a virtual identification number that differs from the actual identification number. An intermediate driver executed by the computing system can expose the window of I/O device memory to a virtual machine. the intermediate driver can map, for the virtual machine, access to the virtual I/O port via the window of I/O device memory using the virtual identification number. The virtual machine can, based on the mapping, transmit an access request to the window of I/O device memory via the virtual I/O port.

### TECHNICAL FIELD

The present disclosure relates generally to virtual machines. More specifically, but not by way of limitation, this disclosure relates to support for legacy input/output device functionality via partial passthrough to virtual machines.

### BACKGROUND

Virtualization may be used to provide some physical components as logical objects to allow running various software modules, concurrently and in isolation from other software modules, on a computing device or a collection of connected computed devices. Virtualization may allow, for example, for consolidating multiple physical servers into one physical server running multiple guest virtual machines to improve the hardware utilization rate. A virtual machine can be a substantially isolated environment that has its own operating system, software applications, and virtualized hardware. For instance, a virtual machine can have a virtual Central Processing Unit (vCPU), a virtual Random Access Memory (vRAM), and other components.

Virtualization may be achieved by running a software layer, often referred to as a hypervisor, to manage processor resources allocated to guest virtual machines. A hypervisor may virtualize the physical layer and provide interfaces between the underlying hardware and guest virtual machines and any guest operating systems. The hypervisor can use these interfaces to manage resources given to applications running on a guest virtual machine.

### BRIEF DESCRIPTION OF THE DRAWINGS

FIG. 1 is a block diagram of an example of a computing environment supporting legacy input/output (I/O) device functionality for virtual machines, according to some aspects of the present disclosure.

FIG. 2 is a block diagram of another example of a computing environment supporting legacy I/O device functionality for virtual machines, according to some aspects of the present disclosure.

FIG. 3 is a flowchart of an example of a process for supporting legacy I/O device functionality for a virtual machine in a computing environment, according to some aspects of the present disclosure.

### DETAILED DESCRIPTION

Some computing environments include input/output (I/O) devices such as peripheral component interface (PCI) devices or other network interface cards. Such computing environments may also host guest virtual machines that may use I/O ports of such I/O devices. For many I/O devices (e.g., PCI express devices), support for such I/O ports may be going away and may not be supported for virtual functions under single root input/output virtualization (SR-IOV). It may be common for guest virtual machines to use unsupported I/O ports, which are also referred to herein as legacy I/O ports (e.g., ports that are partially or fully superseded by replacement ports). Using legacy I/O ports may allow for increasing range of performance of emulation for some computer architecture such as x86 or due to ease of access from limited environments such as firmware. Conventional techniques for providing virtual machine access to legacy I/O ports may involve emulating a legacy device and forwarding requests to, for example, a virtual function. But such emulation may require significant software resources, uses up CPU, and my present a security attack surface for host and guest virtual machines (e.g., with confidential containers).

Some examples of the present disclosure can overcome one or more of the issues mentioned above by using an intermediate driver to expose a window of I/O device memory of an I/O device to a virtual machine. The I/O device may no longer support legacy I/O ports for the virtual machine. To provide legacy I/O port functionality to the virtual machine, the intermediate driver can map access to a virtual I/O port (thus emulating the legacy I/O port) for the virtual machine to the window of I/O device memory. The I/O device can have an actual identification number (e.g., a device identifier (ID) and a vendor ID) that is matched to an existing driver in the host of the computing system. The virtual I/O port may have a virtual identification number (e.g., a different device ID and vendor ID) that can match to a legacy driver in the virtual machine and not to the existing driver in the host. As a result, the existing driver binds to the actual identification number without changes, while in the virtual machine, the legacy driver binds and uses the virtual identification number to access the virtual I/O port.

By using an intermediate driver that interfaces with the window of I/O device memory, the virtual machine can utilize legacy I/O port functionalities even if the I/O device does not have a physical version of the legacy I/O port. The techniques described herein can provide legacy I/O port functionalities with less resource consumption than fully emulating a legacy I/O device with a legacy I/O port using conventional techniques. Further, executing the intermediate driver described herein in the hypervisor or in the virtual machine can provide increased security compared to conventional techniques. For instance, executing the intermediate driver in the hypervisor may only involve minimal changes that are easy to secure. Or, when executing the intermediate driver in the virtual machine, both the virtual machine and the intermediate driver can be encrypted. In contrast, may not be possible to use conventional techniques in emulating a legacy I/O port in the virtual machine if the virtual machine is encrypted because conventional techniques may rely on modifying accesses to the virtual machine since such accesses may be encrypted.

In a particular example, an I/O device such as a PCI device that is coupled to a computing system may be a modern version of the device. For instance, previous versions of the I/O device may have included a legacy I/O port. The current I/O device may not include the legacy I/O port or provide the functionality of the legacy I/O port. It may be beneficial for the computing system to still access the functionality of the legacy I/O port, such as for a virtual machine hosted by the computing system. An intermediate driver executing in either the virtual machine or in a hypervisor executing the virtual machine can provide the legacy I/O port functionality to the virtual machine.

For example, the I/O device may have an actual device identifier (ID) and an actual vendor ID pair that is matched to an existing driver in the computing system (also referred to herein as the host). The existing driver can interact with the I/O device using a first window of I/O device memory. The I/O device can present an interface to the hypervisor that exposes access to a second window of I/O device memory. The second window of I/O device memory may be offset beyond the area used by the existing driver (e.g., beyond the first window of I/O device memory). The second window of I/O device memory can match the memory layout of a legacy I/O port.

The second window of I/O device memory can be used by an intermediate driver that is executing either in the hypervisor or in the virtual machine. For example, the intermediate driver can expose a virtual device ID and virtual vendor ID to the virtual machine. The virtual device ID and virtual vendor ID may be matched to a legacy driver in the virtual machine that is used for accessing the legacy I/O port. From the perspective of the virtual machine, the virtual machine is connected to a legacy I/O port, even thought the I/O device does not include a legacy I/O port. The legacy driver may not bind to the actual device ID and actual vendor ID used by the existing driver in the host. Thus, the intermediate driver can translate between the actual device ID/actual vendor ID pair and the virtual device ID/virtual vendor ID pair used by the virtual machine. the intermediate driver can also remap virtual machine accesses to the legacy I/O port (which does not physically exist) by adding an offset to the access request and sending the offset access request to the second window of I/O device memory. The result returned from the second window of I/O device memory can be provided to the virtual machine by the intermediate driver.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

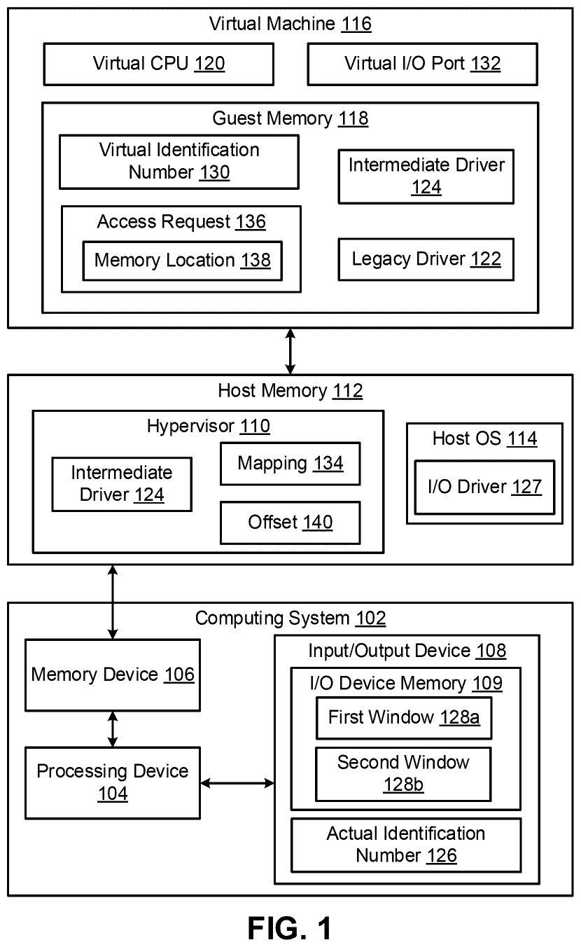

FIG. 1 is a block diagram of an example of a computing system 102 supporting legacy input/output (I/O) device functionality for virtual machines, according to some aspects of the present disclosure. The computing system 102 can in some examples be a distributed system, such as by implementing nodes in a distributed computing network. The computing system 102 can include a processing device 104, a memory device 106, and an input/output (I/O) device 108. The I/O device 108 can in some examples be a peripheral component interface (PCI) card, such as a PCI express card. The I/O device 108 can include I/O device memory 109. The computing system 102 can execute software to provide a hypervisor 110 in host memory 112 that resides in the memory device 106. The host memory 112 can also include a host operating system (OS) 114.

The computing system 102 can run a virtual machine 116 by executing the hypervisor 110 and the host OS 114. In some examples, the host OS 114 can execute the hypervisor 110. In other examples, the computing system 102 can execute the hypervisor 110 separately from, or exclusive of, the host OS 114. The hypervisor 110 can virtualize the physical layer of the computing system 102, including processors, memory devices, etc., and may present this virtualization to the virtual machine 116 as devices, including virtual processors, and the like. The virtual machine 116 may run any type of dependent, independent, and compatible applications on the underlying hardware and host OS 114. In the example depicted in FIG. 1, the virtual machine 116 may be executing a guest memory 118 which may include, for example, a guest OS that utilizes underlying hardware, referred to herein as a virtual central processing unit (CPU) 120.

Previous versions of the I/O device 108 that included a physical I/O port may have been virtualized for the virtual machine 116. The virtual machine 116 may have utilized a legacy driver 122 to interact with the virtualized I/O port in the previous version of the I/O device 108. But the previous version of the I/O device 108 may be updated with a newer version. The current I/O device 108 may not include a physical I/O port and thus the previously included I/O port can be referred to as a legacy I/O port that was previously accessed by the virtual machine 116 via the legacy driver 122. Although the current I/O device 108 may not support include or support the functionality of the legacy I/O port, it may be beneficial for the virtual machine 116 to still access the legacy I/O port functionalities. Conventional methods for providing legacy I/O port functionalities such as emulating the legacy I/O port in the virtual machine 116 may be computationally expensive or may pose security risks. To securely provide legacy I/O port functionalities to the virtual machine 116 with reduced computational and resource consumption compared to conventional techniques, an intermediate driver 124 can be used.

The intermediate driver 124 can interface with the I/O device 108 to expose portions of I/O device memory 109 to the virtual machine 116. For example, the I/O device 108 may have an actual identification number 126 (e.g., a device ID and vendor ID pair). This actual identification number 126 may be matched to an I/O driver 127 executed in the host OS 114. Thus, the host layer of the computing system 102 can perform typical I/O interactions (which may not include legacy I/O port functionalities) with the I/O device 108 using the I/O driver 127. For example, the I/O driver 127 may send access requests to the I/O device 108 that are fulfilled via a first window 128a of I/O device memory 109. But the actual identification number 126 and the first window 128a of I/O device memory 109 may not be used by the virtual machine 116 for legacy I/O port functionalities. Instead, the I/O device 108 can expose a second window 128b of I/O device memory 109 to the hypervisor 110 and therefore the intermediate driver 124. This second window 128b can be outside of the first window 128a (e.g., beyond the area used by the I/O driver 127). And, the second window 128b can be configured to provide the legacy I/O port functionalities.

The intermediate driver 124 may expose the second window 128b of I/O device memory 109 to the virtual machine 116 to be used for legacy I/O port functionalities. For example, the previously used legacy I/O port may have had an identification number that is different from the actual identification number 126 used by the current I/O device 108. The intermediate driver 124 may expose a virtual identification number 130 to the virtual machine 116. The virtual identification number 130 may be the same as the previously used identification number for the legacy I/O port. The intermediate driver 124 can map access to the second window 128b of I/O device memory 109 to the virtual identification number 130. Thus, the legacy driver 122 can bind to the virtual identification number 130 to access the second window 128b of I/O device memory 109 and may not bind to the actual identification number 126 of the actual I/O device 108. From the perspective of the virtual machine 116, the virtual machine 116 may now have access to a virtual I/O port 132, even though the virtual I/O port 132 is not being emulated by the hypervisor 110 or virtualized in the same manner that the legacy I/O port was virtualized for the virtual machine 116. In this way, the intermediate driver 124 can perform a mapping 134 for the virtual machine 116 to provide access to the virtual I/O port 132 via the second window 128b of I/O device memory 109 using the virtual identification number 130. For example, the legacy driver 122 in the virtual machine 116 can then perform access requests 136 to the virtual I/O port 132 that can be fulfilled using the second window 128b of I/O device memory 109.

For example, the second window 128b of I/O device memory 109 may have an I/O base address register (BAR) layout that matches the legacy IO BAR layout of the legacy I/O device. The I/O device 108 may expose the second window 128b by having an offset 140 within the I/O device memory 109 from the first window 128a. The intermediate driver 124 may expose the second window 128b to the virtual machine 116 by translating memory locations using the offset 140. When the legacy driver 122 executing in the virtual machine 116 sends an access request 136 for a memory location 138 via the virtual I/O port 132, the intermediate driver 124 can translate the memory location 138 to the actual memory location in the second window 128b, such as by adding the offset 140. The intermediate driver 124 may also translate the virtual identification number 130 used in the access request 136 to the actual identification number 126 for the I/O device 108. The intermediate driver 124 can use the actual identification number 126 and the actual memory location with the offset 140 to the virtual memory location 138 (e.g., in the second window 128b of I/O device memory 109) to send a request to the I/O device 108. The I/O device 108 can thus return a result to the access request 136, generated using the actual memory location in the second window 128b of I/O device memory 109, to the intermediate driver 124. The intermediate driver 124 can, if necessary, translate the result and can return the result to the virtual machine 116.

The intermediate driver 124 can be implemented in either the virtual machine 116 or the hypervisor 110. By implementing the intermediate driver 124 in the hypervisor 110, the hypervisor 110 may stay device agnostic. That is, only minimal changes that are easily secured may be made to the hypervisor 110. Executing the intermediate driver 124 in the hypervisor 110 may consume significantly less computing resources than emulating a legacy I/O port in the virtual machine 116. Further, no modifications to the virtual machine 116 may be necessary, as the virtual machine 116 can use the previously used legacy driver 122. When the intermediate driver 124 is executed in the hypervisor 110, the intermediate driver 124 may generate the virtual identification number 130 for use by the virtual machine 116 by modifying the actual identification number 126 of the I/O device 108. For example, the intermediate driver 124 may be part of existing systems that expose virtual hardware to the virtual machine 116.

Implementing the intermediate driver 124 in the virtual machine 116 may also consume significantly fewer computing resources compared to emulating a legacy I/O port. The intermediate driver 124 in the virtual machine 116 may simply remap memory where the IO BAR for the legacy I/O port previously was to the second window 128b of I/O device memory 109. Because the intermediate driver 124 is executed in the virtual machine 116, the intermediate driver 124 may be unable to modify the actual identification number 126 to generate the virtual identification number 130. Instead, the intermediate driver 124 may generate a new virtual identification number 130 (e.g., vendor ID and device ID pair) for the virtual I/O port 132. For example, the intermediate driver 124 in the virtual machine 116 may be a bus driver, such as a virtual PCI bus driver, that can expose a virtual device (e.g., the virtual I/O port 132) to the virtual machine 116.

Executing the intermediate driver 124 in the virtual machine 116 may also allow the virtual machine 116 to be encrypted while still accessing legacy I/O port functionalities. For example, encrypting the virtual machine 116 may also encrypt the intermediate driver 124. Because the intermediate driver 124 is also encrypted, the intermediate driver 124 may enable legacy I/O port functionalities (e.g., via the virtual I/O port 132). If the intermediate driver 124 were not also encrypted, the encrypted virtual machine 116 may not have access to encrypted functionalities of the virtual I/O port 132. This may be in contrast to conventional techniques for providing legacy I/O port functionalities to virtual machines that may rely on modifying accesses to such virtual machines. Such conventional techniques may not be used in encrypted virtual machines as access to legacy I/O port functionalities are also encrypted.

While FIG. 1 depicts a specific arrangement of components, other examples can include more components, fewer components, different components, or a different arrangement of components than is shown in FIG. 1. For example, although one virtual machine 116, one I/O device 108, and one virtual I/O port 132 are depicted, any number of virtual machines, I/O devices, and virtual I/O ports may be included.

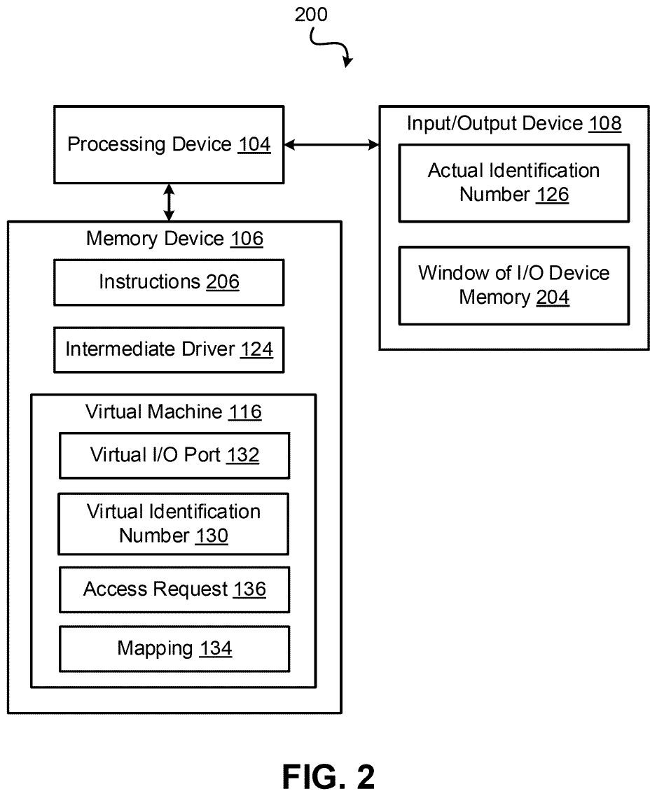

FIG. 2 is a block diagram of another example of a computing environment supporting legacy I/O device functionality for virtual machines, according to some aspects of the present disclosure. The computing environment 200 depicted in FIG. 2 includes a processing device 104 communicatively coupled with a memory device 106. The processing device 104 can additionally be coupled to an input/output (I/O) device 108. In some examples, the components of the computing environment 200, such as the processing device 104, the memory device 106, and the I/O device 108 may be part of a same computing device. In other examples, the processing device 104, the memory device 106, and the I/O device 108 can be included in separate computing devices that are communicatively coupled.

The processing device 104 can include one processing device or multiple processing devices. Non-limiting examples of the processing device 104 include a Field-Programmable Gate Array (FPGA), an application-specific integrated circuit (ASIC), a microprocessor, etc. The processing device 104 can execute instructions 206 stored in the memory device 106 to perform operations. In some examples, the instructions 206 can include processor-specific instructions generated by a compiler or an interpreter from code written in any suitable computer-programming language, such as C, C++, C#, etc.

The memory device 106 can include one memory or multiple memories. The memory device 106 can be non-volatile and may include any type of memory that retains stored information when powered off. Non-limiting examples of the memory device 106 include electrically erasable and programmable read-only memory (EEPROM), flash memory, or any other type of non-volatile memory. At least some of the memory can include a non-transitory computer-readable medium from which the processing device 104 can read instructions 206. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 206.

The I/O device 108 can include an I/O device memory 109. The I/O device memory 109 can be non-volatile and may include any type of memory that retains stored information when powered off. Non-limiting examples of the I/O device memory 109 include electrically erasable and programmable read-only memory (EEPROM), flash memory, or any other type of non-volatile memory. At least some of the memory can include a non-transitory computer-readable medium from which the processing device 104 can read instructions. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions.

In some examples, the I/O device 108 can have an actual identification number 126. The I/O device 108 can expose a window of I/O device memory 204 to the processing device 104. The window of I/O device memory 204 may be associated with a virtual I/O port 132 that has a virtual identification number 130 that is different than the actual identification number 126.

In some examples, the processing device 104 can execute the instructions 206 to perform some or all of the functionality described herein. For example, the processing device 104 can expose, by an intermediate driver 124, the window of I/O device memory 204 associated with the virtual I/O port 132 to a virtual machine 116. The virtual machine 116 may be executed by the processing device 104 (e.g., such as by a hypervisor). The processing device 104 can map (e.g. generate a mapping 134), by the intermediate driver 124 and for the virtual machine 116, access to the virtual I/O port 132 via the window of I/O device memory 204 using the virtual identification number 130. The processing device 104 can transmit, by the virtual machine 116 and based on the mapping 134, an access request 136 to the window of I/O device memory 204 via the virtual I/O port 132.

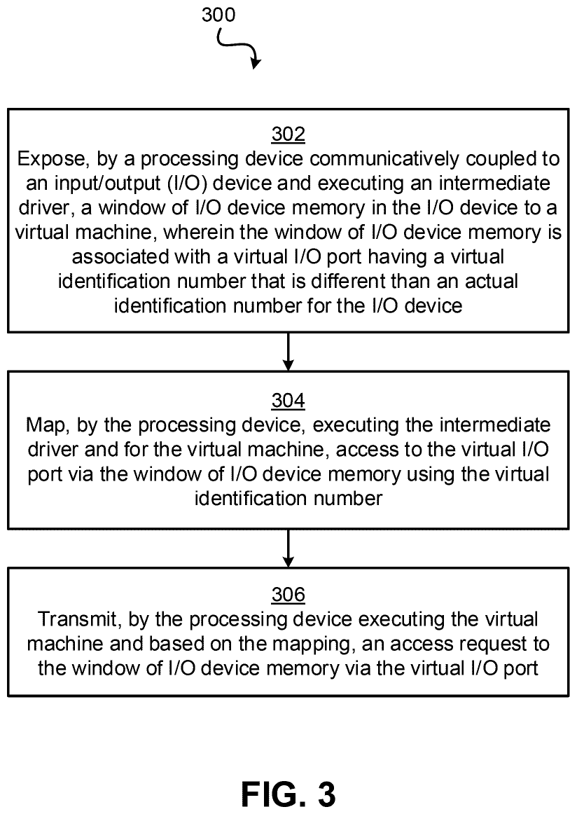

FIG. 3 is a flowchart of an example of a process 300 for supporting legacy I/O device functionality for a virtual machine 116 in a computing environment 200, according to some aspects of the present disclosure. In some examples, the processing device 104 can implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 104, which can be communicatively coupled to an input/output (I/O) device 108 and can execute an intermediate driver 124, can expose a window of I/O device memory 204 in the I/O device 108 to a virtual machine 116. The window of I/O device memory 204 can be associated with a virtual I/O port 132 having a virtual identification number 130 that is different than an actual identification number 126 for the I/O device 108. The I/O device 108 may be a modern version that no longer includes a legacy I/O port that was once included in previous versions of the I/O device 108. For example, the I/O device 108 may be a peripheral component interconnect (PCI) device that does not include a physical I/O port that is a legacy I/O port. Thus, the virtual I/O port 132 may not be a virtualization of a physical I/O port on the I/O device 108. The virtual I/O port 132 may not be an emulation of a physical I/O port and may instead be a mechanism for providing legacy I/O port functionalities. From the perspective of the virtual machine 116, the virtual machine 116 may access a virtual I/O port 132 with the legacy I/O port functionalities. The window of I/O device memory 204 can be at an offset 140 from memory associated with an I/O driver 127 for the I/O device 108 (e.g., a first window 128a). Thus, when the I/O driver 127 accesses the I/O device 108, the I/O driver 127 does not access the window of I/O device memory 204 for the functionalities of the virtual I/O port 132. In other words, the I/O driver 127 binds to the actual identification number 126 and not to the virtual identification number 130.

At block 304, the processing device 104, which can be executing the intermediate driver 124, can map, for the virtual machine 116, access to the virtual I/O port 132 via the window of I/O device memory 204 using the virtual identification number 130. For example, the intermediate driver 124 can generate a mapping 134 between the window of I/O device memory 204 and a virtual window of I/O device memory that a legacy driver 122 in the virtual machine 116 accesses to interact with the virtual I/O port 132. The mapping 134 can be generated based on the offset 140. The legacy driver 122 in the virtual machine 116 may bind to the virtual identification number 130 and not to the actual identification number 126 (e.g., because the intermediate driver 124 exposes the virtual identification number 130 and not the actual identification number 126 to the virtual machine 116).

At block 306, the processing device 104, which can be executing the virtual machine 116, can transmit, based on the mapping 134, an access request 136 to the window of I/O device memory 204 via the virtual I/O port 132. For example, the intermediate driver 124 (e.g., executed by the processing device 104) can transmit the access request 136 from the virtual machine 116 to the window of I/O device memory 204 by adding the offset 140 to a memory location 138 specified in the access request 136. The I/O device 108 can fulfill the access request 136 transmitted by the intermediate driver 124, which can in some examples involve providing legacy I/O port functionalities via the offset memory location in the window of I/O device memory 204. The I/O device 108 can return a response to the access request 136 to the intermediate driver 124, which can translate the response as necessary before returning the response to the virtual machine 116 and/or legacy driver 122.

In some examples, the intermediate driver 124 can be executed by a hypervisor 110 executing the virtual machine 116. In such examples, the hypervisor 110 can expose the virtual I/O port 132 to the virtual machine 116. The hypervisor 110 can execute the intermediate driver 124 to generate the virtual identification number 130 by modifying the actual identification number 126. The legacy driver 122 can then bind to the virtual identification number 130.

In other examples, the intermediate driver 124 can be executed by (e.g., within) the virtual machine 116. In such examples, the intermediate driver 124 in the virtual machine 116 can expose the virtual I/O port to the virtual machine 116. The intermediate driver 124 can map (e.g., generate a mapping 134) access to the virtual I/O port 132 to the virtual I/O port 132 via the window of I/O device memory 204 by generating and assigning the virtual identification number 130 to the virtual I/O port 132. In some examples, the virtual machine 116, the intermediate driver 124 executing within the virtual machine 116, and access to the virtual I/O port 132 (e.g., to the window of I/O device memory 204 associated with legacy I/O port functionalities) can be encrypted.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
an input/output (I/O) device having an actual identification number, wherein the I/O device is configured to expose a window of I/O device memory, wherein the window of I/O device memory is associated with a virtual I/O port having a virtual identification number that is different than the actual identification number;
a processing device communicatively coupled to the I/O device; and
a non-transitory memory device comprising instructions that are executable by the processing device for causing the processing device to:
expose, by an intermediate driver, the window of I/O device memory associated with the virtual I/O port to a virtual machine;
map, by the intermediate driver and for the virtual machine, access to the virtual I/O port via the window of I/O device memory using the virtual identification number; and
transmit, by the virtual machine and based on the mapping, an access request to the window of I/O device memory via the virtual I/O port.

2. The system of claim 1, wherein the window of I/O device memory is at an offset from memory associated with an I/O driver for the I/O device, and wherein the non-transitory memory device further comprises instructions that are executable by the processing device for causing the intermediate driver to:
map, for the virtual machine, access to the virtual I/O port to the window of I/O device memory based on the offset;
transmit the access request from the virtual machine to the window of I/O device memory by adding the offset to a memory location specified in the access request; and
return, to the virtual machine, a response to the access request.

3. The system of claim 1, wherein the intermediate driver is executed by a hypervisor executing the virtual machine, and wherein the non-transitory memory device further comprises instructions that are executable by the processing device for causing the processing device to:
expose, by the hypervisor, the virtual I/O port to the virtual machine; and
generate, by the hypervisor executing the intermediate driver, the virtual identification number by modifying the actual identification number.

4. The system of claim 1, wherein the intermediate driver is executed by the virtual machine, and wherein the non-transitory memory device further comprises instructions that are executable by the processing device for causing the processing device to:
expose, by the intermediate driver, the virtual I/O port to the virtual machine; and
map, by the intermediate driver, access to the virtual I/O port via the window of I/O device memory by generating and assigning the virtual identification number to the virtual I/O port.

5. The system of claim 4, wherein the virtual machine, the intermediate driver, and access to the virtual I/O port are encrypted.

6. The system of claim 1, wherein the non-transitory memory device further comprises instructions that are executable by the processing device for causing the processing device to map access to the virtual I/O port to the window of I/O device memory by:
binding a legacy driver for I/O ports in the virtual machine to the virtual identification number for the virtual I/O port,
wherein an I/O driver executed in a host for the virtual machine is configured to bind to the actual identification number for the I/O device.

7. The system of claim 1, wherein the I/O device is a peripheral component interconnect (PCI) device that does not comprise a physical I/O port.

8. A method comprising:
exposing, by a processing device communicatively coupled to an input/output (I/O) device and executing an intermediate driver, a window of I/O device memory in the I/O device to a virtual machine, wherein the window of I/O device memory is associated with a virtual I/O port having a virtual identification number that is different than an actual identification number for the I/O device;
mapping, by the processing device executing the intermediate driver and for the virtual machine, access to the virtual I/O port via the window of I/O device memory using the virtual identification number; and
transmitting, by the processing device executing the virtual machine and based on the mapping, an access request to the window of I/O device memory via the virtual I/O port.

9. The method of claim 8, wherein the window of I/O device memory is at an offset from memory associated with an I/O driver for the I/O device, and wherein the method further comprises executing the intermediate driver to:
map, for the virtual machine, access to the virtual I/O port to the window of I/O device memory based on the offset;
transmit the access request from the virtual machine to the window of I/O device memory by adding the offset to a memory location specified in the access request; and
return, to the virtual machine, a response to the access request.

10. The method of claim 8, wherein the intermediate driver is executed by a hypervisor executing the virtual machine, and wherein the method further comprises:
exposing, by the hypervisor, the I/O device to the virtual machine; and
generating, by the hypervisor executing the intermediate driver, the virtual identification number by modifying the actual identification number.

11. The method of claim 8, wherein the intermediate driver is executed by the virtual machine, and wherein the method further comprises:
exposing, by the intermediate driver, the virtual I/O port to the virtual machine; and
mapping, by the intermediate driver, access to the virtual I/O port via the window of I/O device memory by generating and assigning the virtual identification number to the virtual I/O port.

12. The method of claim 11, wherein the virtual machine, the intermediate driver, and access to the virtual I/O port are encrypted.

13. The method of claim 8, wherein mapping access to the virtual I/O port to the window of I/O device memory further comprises:
binding a legacy driver for I/O ports in the virtual machine to the virtual identification number for the virtual I/O port,
wherein an I/O driver executed in a host for the virtual machine is configured to bind to the actual identification number for the I/O device.

14. The method of claim 8, wherein the I/O device is a peripheral component interconnect (PCI) device that does not comprise a physical I/O port.

15. A non-transitory computer-readable medium comprising program code that is executable by a processing device for causing the processing device to:
expose, by an intermediate driver, a window of I/O device memory in an I/O device to a virtual machine, wherein the I/O device is communicatively coupled to the processing device, and wherein the window of I/O device memory is associated with a virtual I/O port having a virtual identification number that is different than an actual identification number for the I/O device;
map, by the processing device executing the intermediate driver and for the virtual machine, access to the virtual I/O port via the window of I/O device memory using the virtual identification number; and
transmit, by the processing device executing the virtual machine and based on the mapping, an access request to the window of I/O device memory via the virtual I/O port.

16. The non-transitory computer-readable medium of claim 15, wherein the window of I/O device memory is at an offset from memory associated with an I/O driver for the I/O device, and wherein the program code is further executable by the processing device for causing the intermediate driver to:
map, for the virtual machine, access to the virtual I/O port to the window of I/O device memory based on the offset;
transmit the access request from the virtual machine to the window of I/O device memory by adding the offset to a memory location specified in the access request; and
return, to the virtual machine, a response to the access request.

17. The non-transitory computer-readable medium of claim 15, wherein the intermediate driver is executed by a hypervisor executing the virtual machine, and wherein the program code is further executable by the processing device for causing the processing device to:
expose, by the hypervisor, the I/O device to the virtual machine; and
generate, by the hypervisor executing the intermediate driver, the virtual identification number by modifying the actual identification number.

18. The non-transitory computer-readable medium of claim 15, wherein the intermediate driver is executed by the virtual machine, and wherein the program code is further executable by the processing device for causing the processing device to:
expose, by the intermediate driver, the virtual I/O port to the virtual machine; and
map, by the intermediate driver, access to the virtual I/O port via the window of I/O device memory by generating and assigning the virtual identification number to the virtual I/O port.

19. The non-transitory computer-readable medium of claim 18, wherein the virtual machine, the intermediate driver, and access to the virtual I/O port are encrypted.

20. The non-transitory computer-readable medium of claim 15, wherein the program code is further executable by the processing device for causing the processing device to map access to the virtual I/O port to the window of I/O device memory by:
binding a legacy driver for I/O ports in the virtual machine to the virtual identification number for the virtual I/O port,
wherein an I/O driver executed in a host for the virtual machine is configured to bind to the actual identification number for the I/O device.
